(19) United States
(12) Patent Application Publication
(10) Pub. No.: US 2015/0081502 A1
(43) Pub. Date: Mar. 19, 2015

(54) METHODS AND APPARATUS TO IMPLEMENT TWO-STEP TRADE ACTION EXECUTION

(71) Applicant: Trading Technologies International, Inc., Chicago, IL (US)

(72) Inventor: Scott F. Singer, Green Oaks, IL (US)

(73) Assignee: Trading Technologies International, Inc., Chicago, IL (US)

(21) Appl. No.: 14/031,316

(22) Filed: Sep. 19, 2013

(51) Int. Cl. G06Q 40/04

(52) U.S. Cl. CPC G06Q 40/04
USPC 705/37

(57) ABSTRACT

Methods and apparatus to implement two-step trade action execution are disclosed herein. An example method includes detecting, via a user interface generated by a computing device, an activation event associated with an interface control corresponding to a trade action, wherein the activation event is a gestural input received via the generated user interface. The example method also includes detecting, in response to the detected activation event, an enabling event associated with the interface control. The example method also includes determining whether the enabling event satisfies one or more activation criterion, and in response to the enabling event satisfying the one or more activation criterion, initiating the trade action associated with the activated interface control.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

Advances in mobile devices have resulted in improved touch screens that allow users to directly interact with what is displayed. For example, a user may play a game, write an email, file taxes, etc., by directly interacting with the user interface of the touch screen, rather than using an intermediary device such as a mouse, keyboard, touchscreen, etc.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a flow diagram representative of example machine readable instructions that may be executed to implement disclosed embodiments.

FIGS. 5a-5d illustrate an example trading window in accordance with disclosed embodiments.

FIG. 6 illustrates a block diagram of an example system which may be employed with certain disclosed embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to electronic trading environments and, more particularly, to methods and apparatus to implement two-step trade action execution.

In general, users desire to be able to react more quickly than other market participants. For example, market participants (or traders or other users) generally desire to be “first-to-market” (e.g., have orders entered prior to other market participants entering the same or similar orders). It is therefore advantageous to improve the way market data is displayed to the user and to allow the user to make fast and accurate order entry. The slightest speed advantage may give a user a significant competitive advantage.

Trading applications allow users to initiate trade actions. In some examples, a trading application may include trading windows for displaying market data or a portion of the market data. In addition, the trading windows may include trade action controls for initiating or executing trade actions. A trade action control is a button, cell, or area on a trading screen that corresponds to a particular trade action. In some examples, when the trade action control is enabled, the trading device may execute or perform the corresponding trade action, such as placing, cancelling or changing a trade order.

Touch screens allow users to directly or indirectly interact with the trading application. In some examples, a user operates (e.g., executes) the trading application by directly interacting with the components displayed via the touch screen. For example, a user may execute a trade action (e.g., communicate a sell order, a buy order, etc.) by directly selecting a trade action control (e.g., a button) corresponding to the trade action. Directly interacting with the trading application may be useful in that it eliminates (or nearly eliminates) the need for additional components to execute trade actions (e.g., using a computer mouse to select a trade action control). As a result, trade actions may be executed more efficiently by the user. Although touch screens allow for relatively quicker direct interaction, touch screens also increase the chances of accidentally selecting a trade action control. To this end, examples disclosed herein include preventing unintentional selections on critical user interface controls on a touch-screen. Some examples disclosed herein include detecting an enabling event for a “disabled” or “locked” user interface control before the corresponding trade action can be executed.

Embodiments disclosed herein recognize that directly interacting with a trading application may lead to instances where a trade action control is accidently selected. Unlike prior trading systems, embodiments disclosed herein implement two-step trade action execution by initially disabling the trade action component. According to embodiments disclosed herein, the trade action component is enabled when an activation criterion is satisfied. According to embodiments disclosed herein, the trade action corresponding to the enabled trade action component may then be executed. In some examples, the trade action executes automatically when the corresponding trade action control is enabled.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Certain embodiments provide a method including detecting, via a user interface generated by a computing device, an activation event associated with an interface control corresponding to a trade action, wherein the activation event is a gestural input received via the generated user interface. The example method also includes detecting, in response to the detected activation event, an enabling event associated with the interface control. The example method also includes determining whether the enabling event satisfies one or more activation criterion, and in response to the enabling event satisfying the one or more activation criterion, initiating the trade action associated with the activated interface control.

Certain embodiments provide an apparatus including an activation event detecting module to detect an activation event via a user interface, the user interface to include an interface control that is to correspond to a trade action, and wherein the user interface is to receive the activation event as a gestural input. The example apparatus also includes an enabling event detecting module to detect an enabling event associated with the interface control. The example apparatus also includes a criterion satisfying detection module to compare the enabling event to an activation criterion. The example apparatus also includes a trade action execution module to, based on the comparison, execute the trade action that is to correspond to the interface control.

Certain embodiments provide a tangible computer readable storage medium including computer program code to be executed by a processor, the computer program code, when executed, to implement a method. The example computer program code also includes the method detecting, via a user interface generated by a computing device, an activation event associated with an interface control corresponding to a trade action, wherein the activation event is a gestural input received via the generated user interface. The example computer program code also includes the method detecting, in response to the detected activation event, an enabling event associated with the interface control. The example computer program code also includes the method determining whether the enabling event satisfies one or more activation criterion, and in response to the enabling event satisfying the one or more activation criterion, initiating the trade action associated with the activated interface control.

### II. Example Electronic Trading System

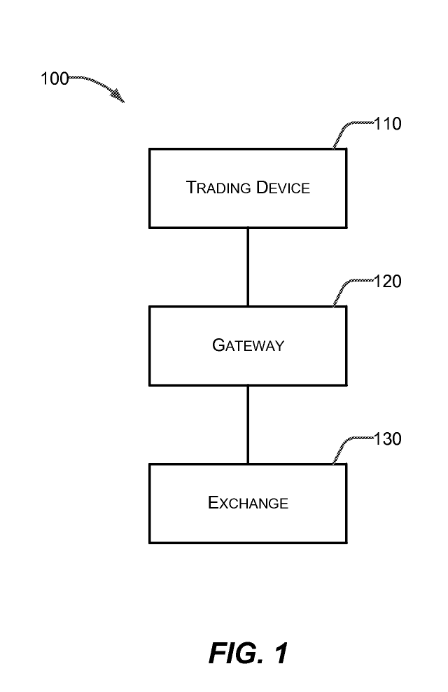

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. Due to the quantity available, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order, etc. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals and to exclude transmission media.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a user may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

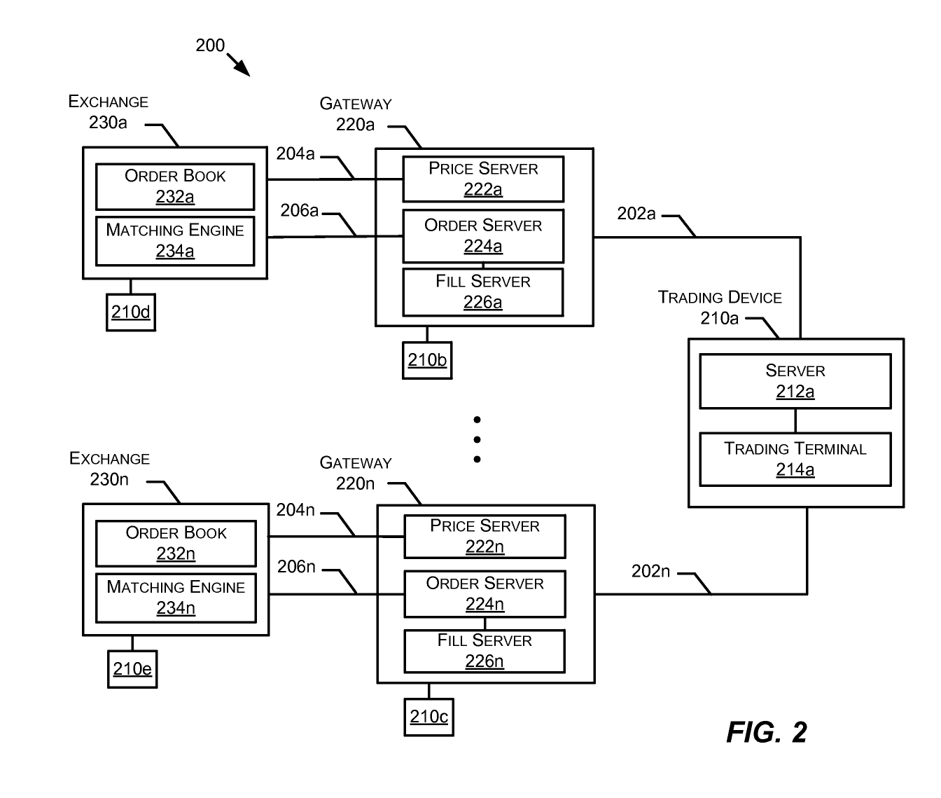

FIG. 2 illustrates a block diagram of another example electronic trading system 200 in which certain embodiments may be employed. In this example, a trading device 210a is in communication with an exchange 230a through a gateway 220a. The following discussion mainly focuses on the trading device 210a, gateway 220a, and the exchange 230a. However, the trading device 210a may also be connected to and communicate with any number of gateways 220n connected to exchanges 230n. The communication between the trading device 110a and other exchanges 230n may be the same, similar, or different than the communication between the trading device 210a and exchange 230a. Generally, each exchange has its own preferred techniques and/or formats for communicating with a trading device, a gateway, the user, or another exchange.

The trading device 210a, which may be similar to the trading device 110 in FIG. 1, may include a server 212a in communication with a trading terminal 214a. The server 212a may be located geographically closer to the gateway 120 than the trading terminal 214a. As a result, the server 212a latency benefits that are not afforded to the trading terminal 214a. In operation, the trading terminal 214a may provide a trading screen to a user and communicate commands to the server 212a for further processing. For example, a trading algorithm may be deployed to the server 212a for execution based on market data. The server 212a may execute the trading algorithm without further input from the user. In another example, the server 212a may include a trading application providing automated trading tools and communicate back to the trading terminal 214a. The trading device 210a may include, additional, different, or fewer components.

The trading device 210a may communicate with the gateway 220a using one or more communication networks. As used herein, a communication network is any network, including the Internet, which facilitates or enables communication between, for example, the trading device 210a, the gateway 220a and the exchange 220a. For example, as shown in FIG. 2, the trading device 210a may communicate with the gateway 220a across a multicast communication network 202a. The data on the network 202a may be logically separated by subject (for example, prices, orders, or fills). As a result, the server 212a and trading terminal 214a can subscribe to and receive data (for example, data relating to prices, orders, or fills) depending on their individual needs.

The gateway 220a, which may be similar to the gateway 120 of FIG. 1, may include a price server 222a, order server 224a, and fill server 226a. The gateway 220a may include additional, different, or fewer components. The price server 222a may process price data. Price data includes data related to a market for one or more tradeable objects. The order server 224a may process order data. Order data is data related to a user's trade orders. For example, order data may include order messages, confirmation messages, or other types of messages. The fill server collects and provides fill data. Fill data includes data relating to one or more fills of trade orders. For example, the fill server 226a may provide a record of trade orders, which have been routed through the order server 224a, that have and have not been filled. The servers 222a, 224a, 226a may run on the same machine or separate machines.

The gateway 220a may communicate with the exchange 230a using one or more communication networks. For example, as shown in FIG. 2, there may be two communication networks connecting the gateway 220a and the exchange 230a. The network 204a may be used to communicate market data to the price server 222a. In some instances, the exchange 230a may include this data in a data feed that is published to subscribing devices. The network 206a may be used to communicate order data.

The exchange 230a, which may be similar to the exchange 130 of FIG. 1, may include an order book 232a and a matching engine 234a. The exchange 230a may include additional, different, or fewer components. The order book 232a is a database that includes data relating to unmatched quantity of trade orders. For example, an order book may include data relating to a market for a tradeable object, such as the inside market, market depth at various price levels, the last traded price, and the last traded quantity. The matching engine 234a may match contra-side bids and offers. For example, the matching engine 234a may execute one or more matching algorithms that match contra-side bids and offers. A sell order is contra-side to a buy order with the same price. Similarly, a buy order is contra-side to a sell order with the same price.

In operation, the exchange 230a may provide price data from the order book 232a to the price server 222a and order data and/or fill data from the matching engine 234a to the order server 224a. Servers 222a, 224a, 226a may translate and communicate this data back to the trading device 210a. The trading device 210a, for example, using a trading application, may process this data. For example, the data may be displayed to a user. In another example, the data may be utilized in a trading algorithm to determine whether a trade order should be submitted to the exchange 230a. The trading device 210a may prepare and send an order message to the exchange 230a.

In certain embodiments, the gateway 220a is part of the trading device 210a. For example, the components of the gateway 220a may be part of the same computing platform as the trading device 210a. As another example, the functionality of the gateway 220a may be performed by components of the trading device 210a. In certain embodiments, the gateway 220a is not present. Such an arrangement may occur when the trading device 210a does not need to utilize the gateway 220a to communicate with the exchange 230a, for example. For example, if the trading device 210a has been adapted to communicate directly with the exchange 230a.

Additional trading devices 210b-210e, which are similar to trading device 210a, may be connected to one or more of the gateways 220a-220n and exchanges 230a-230n. Furthermore, additional gateways, similar to the gateway 220a, may be in communication with multiple exchanges, similar to the exchange 230a. Each gateway may be in communication with one or more different exchanges, for example. Such an arrangement may, for example, allow one or more trading devices 210a to trade at more than one exchange (and/or provide redundant connections to multiple exchanges).

### IV. Example Computing Device

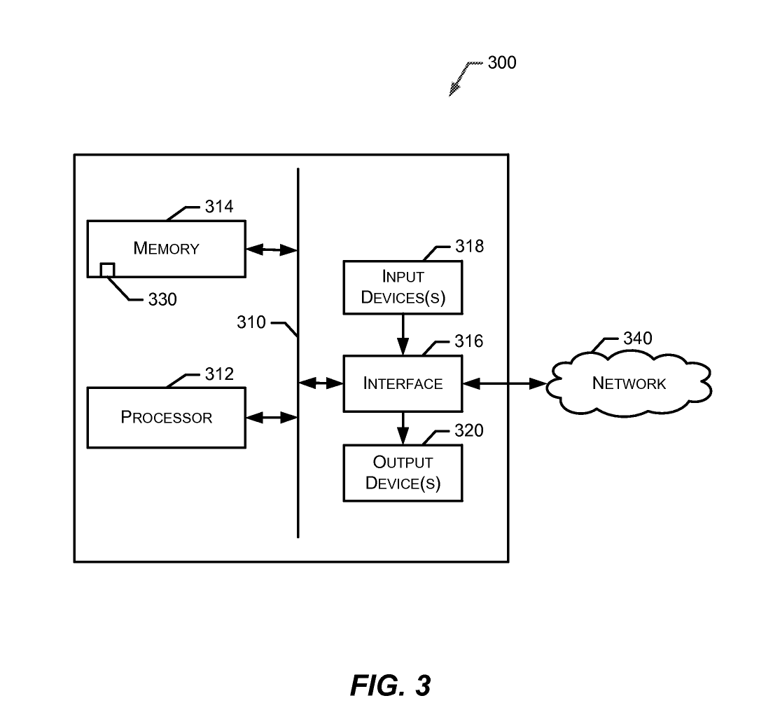

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 and/or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals and to exclude transmission media. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Example Systems and Methods for Two-Step Trade Action Execution

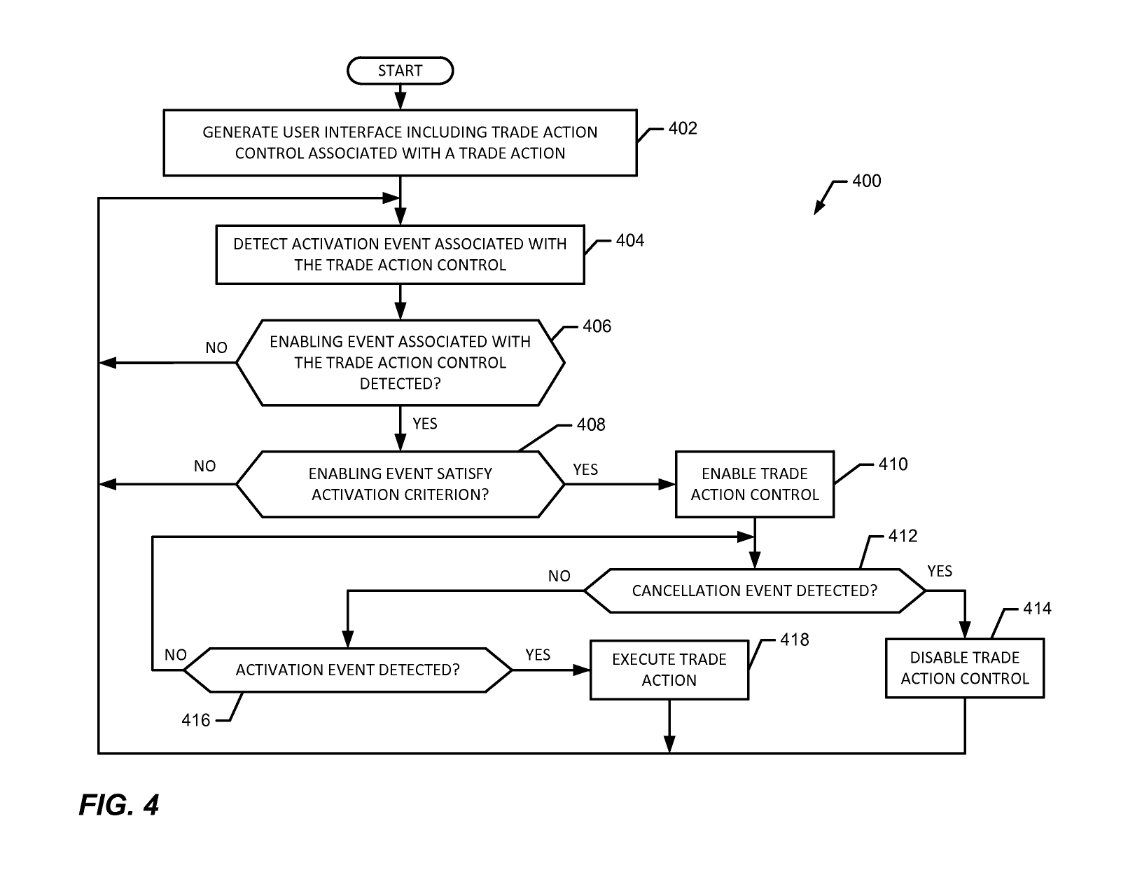

FIG. 4 is a flow diagram representative of example operations that can be executed to implement the teachings of this disclosure. The example operations of FIG. 4 can be implemented by, for example, the example trading device 110 of FIG. 1 and/or the example trading device 210a of FIG. 2. While the example trading device 110 of FIG. 1 is described as executing the example operations of FIG. 4 below, any suitable device can execute the examples operations of FIG. 4. The example operations of FIG. 4 implement two-step trade action execution by including a first step enabling a trade action control associated with a trade action and a second step facilitating execution of the trade action.

In the example of FIG. 4, a trade action control (or an interface control) such as a BUY control, a SELL control, etc., is in a disabled state until an enabling event satisfying an activation criterion associated with the trade action control is identified. A trade action control in the disabled state (or a disabled trade action control) may appear different than a trade action control in an enabled state (or an enabled trade action control). For example, a disabled trade action control may be marked, shaded a different color than an enabled trade action control, appear depressed or lower in comparison to an enabled trade action control, etc.

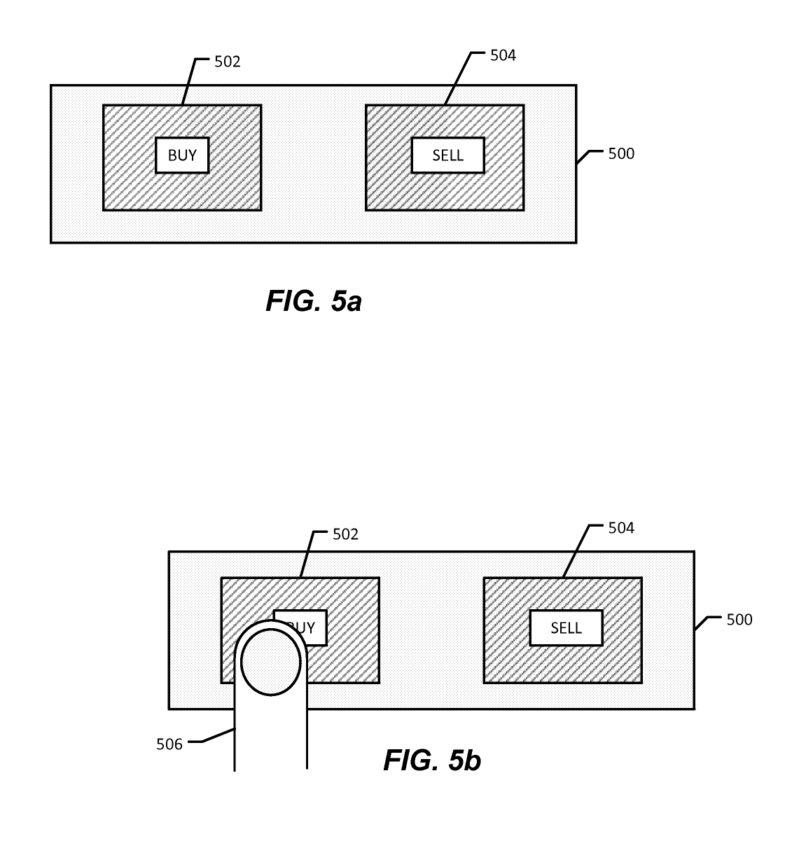

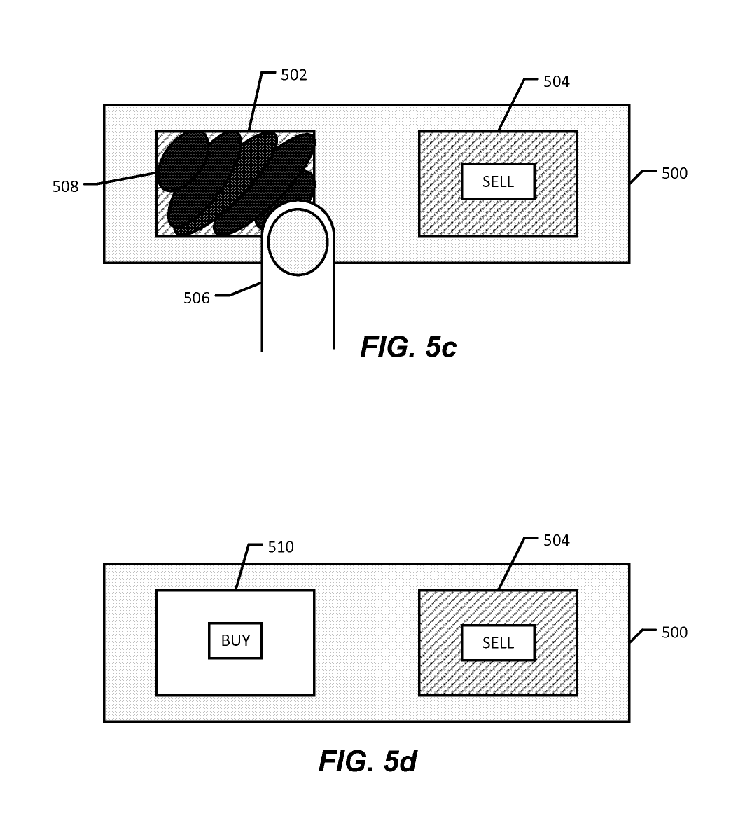

The example process 400 of FIG. 4 begins at block 402 by generating a user interface including a trade action control(s) displayed in a disabled state. The trade action control is associated with a corresponding trade action(s). For example, a trade application may generate a user interface including one or more windows displaying various components of market information or data. In some examples, window(s) may represent information for tradeable objects in which a trader (or other user) has submitted orders or received fills, or historical information gathered during a current or one or more previous trading sessions (e.g., a recent trading session, a trading session from a previous day, week, month, etc.). In some examples, the window(s) display synthetic and/or exchange-traded strategies created by the user. In some examples, the generated window(s) include trade action (or interface) controls that correspond to a trade action. For example, a “BUY” control corresponds to a buy order, a “SELL” control corresponds to a sell order, etc. FIG. 5a illustrates an example portion of a trading window 500 including an example BUY control 502 and an example SELL control 504. In the illustrated example of FIG. 5a, the trade action controls 502, 504 are displayed in a disabled state, which is represented by diagonal lines. The disabled state may be implemented to, for example, prevent accidental execution of the corresponding trade action (e.g., a BUY order, a SELL order, etc.) and/or prevent unwanted modification(s) of an existing trade order.

At block 404, an activation event associated with a disabled trade action control is detected. For example, a trade action control such as the BUY control may be selected via the touch-screen and switched between a disabled state and an active state. Activation events include directly or indirectly “touching” (e.g., selecting) the trade action control by a gestural input via, for example, a finger, a stylus, a mouse, a pen, etc. In some examples, gestural inputs include selecting, holding, swiping, scrubbing, etc. the trade action control. For example, the user may select (e.g., engage) a trade action control displayed in a disabled state for a period of time (e.g., two seconds), may swipe along the touch-screen (e.g., from left to right, etc.), may repeatedly swipe across the trade action control similar to “scratching” a lottery ticket to reveal a hidden number, etc. The action and/or gesture used to engage the trade action control corresponds to an activation event and serves to transition the trade action control to an active state. FIG. 5b illustrates the example trading window 500 including the example trade action controls 502, 504. In the illustrated example of FIG. 5b, an activation event (e.g., selecting a control element) corresponding to a trader's gesture of rubbing or swiping a finger 506 over the BUY control 502 is detected.

At block 406, a determination is made whether an enabling event associated with the trade action control is detected. In some examples, an enabling event is a second gestural input. For example, a user may select the BUY control, and then start scrubbing the BUY control. In some such instances, selecting the BUY control is the activation event and scrubbing the BUY control is the enabling event. In some examples, an enabling event is a continuation of the activation event. For example, an activation event may include selecting a SELL control and the associated enabling event may include continuing to select the SELL control (e.g., holding) for a period of time. FIG. 5c illustrates the example trading window 500 including the example trade action controls 502, 504. In the illustrated example of FIG. 5b, an enabling event 508 (e.g., scrubbing) via the example finger 506 is detected and the enabling event 508 covers a portion of the BUY control 502. If no enabling event is detected, control returns to block 404 to detect an activation event. For example, if no enabling event is detected within five (5) seconds of a corresponding activation event, then control may return to block 404. Otherwise, control proceeds to block 408.

At block 408, a determination is made whether the detected enabling event satisfies one or more activation criterion associated with the trade action control. In some examples, the activation criterion depends on the enabling event. For example, to satisfy an activation event corresponding to a scrubbing gesture, a threshold amount of the trade action control is “scribbled” on. In one embodiment, the threshold amount may be set low such that scrubbing twenty percent (20%) of a control element corresponds to the selection or activation of that control element. Similarly, the threshold amount may be set high such that scrubbing eighty percent (80%) of a control element corresponds to the selection or activation of that control element. The sensitivity of the threshold amount may be adjusted by varying the selection percentage that corresponds to the activation criterion. Activation criterion may (also) include minimum or maximum amounts of time. For example, an activation criterion may include selecting (or holding down) a trade action control for two seconds. In some examples, one or more activation criterion may correspond to one or more enabling events. For example, a user may scribble across the SELL control for two seconds or select and hold the SELL control for two seconds to satisfy the activation criterion for the SELL control.

In response to the enabling event satisfying the one or more activation criterion, at block 410, the trade action control is enabled or otherwise displayed in an active state. For example, the BUY control may appear “elevated” or raised in comparison to the interface. In some examples, the user interface may update to reflect the current state (e.g., enabled or disabled) of the trade action control(s). In some examples, satisfying the one or more activation criterion may enable more than one trade action control (e.g., a BUY control and a SELL control, etc.). FIG. 5d illustrates the example trading window 500 including the example disabled SELL control 504 and an example enabled BUY control 510. When the trade action control is in the enabled state, selecting the trade action controls causes an associated trade action to execute. For example, selecting an enabled BUY control causes the trading application to send a BUY message to, for example, the example exchange 130 of FIG. 1.

In some examples, when an activation criterion satisfying enabling event is identified, the associated trade action control is enabled until the trade action control is executed or a non-execution event is detected. For example, a cancelling event such as selecting a second interface control, or a timer expiring, etc. may disable the enabled trade action control. In some such examples, the user interface may update to reflect the current state (e.g., enabled or disabled) of the trade action control(s).

At block 412, a cancellation event is detected. A cancellation event may include, for example, detecting an activation event at a second interface control (e.g., a CANCEL control) or other selection or activity occurring away from the enabled trade action control. In some examples, a cancellation event may include not detecting an activation event of the enabled trade action control before a timer expires. For example, enabling a trade action control may initiate a timer (e.g., five seconds). In some such examples, if the timer expires before the trade action is executed, the enabled trade action control is disabled.

When a cancellation event is identified (block 412), at block 414, the enabled trade action control is disabled. Control then proceeds back to block 404 to detect an activation event.

Otherwise, when a cancellation event is not identified (block 412), at block 416, the process 400 determines whether an activation event of the enabled trade action control has been detected. When an activation event is not detected (block 416), control returns to block 412 to determine whether a cancellation event is identified. In contrast, when an activation event (e.g., a selection) of the enabled trade action control is detected (block 416), at block 418, the associated trade action executes. In some examples, the associated trade action may execute without the activation event. That is, when the activation criterion for a trade action control is satisfied, the associated trade action automatically executes. For example, once a threshold amount of the BUY control has been scribbled on, the trading device 110 sends a BUY message to, for example, the exchange 130 of FIG. 1. Control then returns to block 404 to detect an activation event.

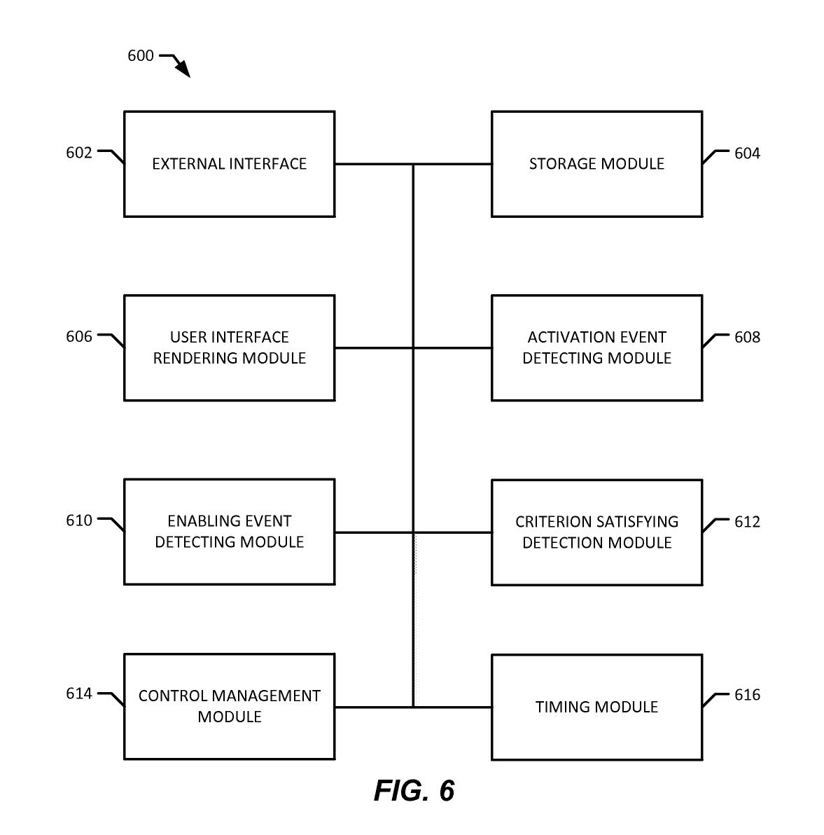

FIG. 6 is a block diagram of an example system 600 that may implement and/or execute the example operations of FIG. 4. In some examples, the system 600 may be implemented as part of software (or an application) associated with the trading device 110 of FIG. 1, the gateway 120 of FIG. 1 and/or the electronic exchange 130 of FIG. 1. In some examples, the system 600 may be implemented as computer implemented code or instructions operable independent of software associated with the trading device 110 of FIG. 1, the gateway 120 of FIG. 2 and/or the electronic exchange 130 of FIG. 1. In some examples, the features and functionality of the system 600 may be implemented in hardware operable in connection with the trading device 110 of FIG. 1, the gateway 120 of FIG. 1 and/or the electronic exchange 130 of FIG. 1.

The example system 600 of FIG. 6 includes an example external interface 602, an example storage module 604, an example user interface rendering module 606, an example activation event detecting module 608, an example enabling event detecting module 610, an example criterion satisfying detection module 612, an example control management module 614 and an example timing module 616. In some examples, the external interface 602 receives user input via, for example, the trading device 110 of FIG. 1. In some examples, the external interface 602 receives market information from, for example, the gateway 120 of FIG. 1, the electronic exchange 130 of FIG. 1 and/or an intermediary component. For example, market information updates may be communicated from the gateway 120 to the trading device 110. In some such examples, the external interface 602 of the example system 600 receives the market information updates and stores the full market information updates in an example storage module 604. The example storage module 604 may be implemented with any number and/or type(s) of tangible storage medium(s), memory(-ies), memory device(s) and/or memory disc(s). In some examples, the external interface 602 outputs information to display on a trading screen. For example, the external interface 602 may communicate to the trading screen what market information to display in a trading window.

The example user interface rendering module 606 of the example system 600 renders the displayed user interface. For example, the user interface rendering module 606 generates a user interface including one or more trade action controls for the trading window. In some examples, the user interface rendering module 606 updates a portion of the user interface. For example, the user interface rendering module 606 may change a trade action control from disabled to enabled or enabled to disabled. In addition, when market information is received via the external interface 602, the user interface rendering module 606 may update the relevant portions of the user interface.

The example activation event detecting module 608 of the example system 600 detects activation events based on user interactions detected on a touch-screen of the trading device 110. In some examples, activation events include directly or indirectly interacting with components (e.g., trade action controls) displayed in the trading window rendered by the user interface rendering module 606. In some examples, the activation event detecting module 608 identifies the gestural input (e.g., selecting, holding, swiping, scrubbing, sweeping, etc.) corresponding to the activation event. In some examples, the activation event detecting module 608 identifies whether the activation event corresponds to a trade action control and, in addition, the corresponding trade action control. For example, the activation event detecting module 608 may identify that a detected activation event corresponds to a selection of a BUY control, or that the detected activation event corresponds to a sweeping motion of a QTY control.

The example enabling event detecting module 610 of the example system 600 detects enabling events based on user interactions detected on the touch-screen of the trading device 110. In some examples, the enabling event detecting module 610 detects user interactions or gestural inputs similar to the example activation event detecting module 608. In the illustrated example of FIG. 6, the enabling event detecting module 610 sends a message including enabling event information to the example criterion satisfying detection module 612 in response to detecting an enabling event. Enabling event information may include, for example, a type of gestural input detected (e.g., a selecting, a holding, a sweeping, etc.), a duration the gestural input was detected, a portion of the trade action control covered by the gestural input, etc.

The example criterion satisfying detection module 612 of the example system 600 determines whether one or more activation criterion associated with the trade action control identified by the activation event detecting module 608 is satisfied based on the enabling event information received from the example enabling event detecting module 610. In some examples, the criterion satisfying detection module 612 may use a data structure such as a lookup table to identify the one or more activation criterion that apply to the information received from the activation event detecting module 608 and the enabling event detecting module 610. The criterion satisfying detection module 612 compares the results returned from the data structure to determine whether one or more activation criterion are satisfied. Based on the comparison, the criterion satisfying detection module 612 the information included in a message sent to the example control management module 614. For example, the information may include which trade action control was enabled or disabled.

The example control management module 614 manages the state of the one or more trade action controls included in the trading window. For example, the control management module 614 may store the state of the one or more trade action controls in a data structure. When a message is received from the example criterion satisfying detection module 612, the control management module 614 updates the status of the control. In some examples, the control management module 614 receives a message from the activation event detecting module 608 when an activation event is detected. In some such examples, the control management module 614 may determine whether the activation event information included in the message is a cancellation event for one or more of the trade action controls. For example, detecting a selection of a disabled trade action control may be ignored by the control management module 614. In some other examples, detecting a selection of an enabled trade action control may cause the control management module 614 to execute the trade action corresponding to the selected trade action control. In some other examples, detecting a non-enabled trade action control selection may cause the control management module 614 to change the status of the enabled trade action control to the disabled state. In some examples, the example control management module 614 may receive a timer expiration message from the example timing module 616. In some such examples, the control management module 614 may change the status of the corresponding enabled trade action control to the disabled state. The example timing module 616 of the illustrated example includes a clock, which may be initiated when, for example, a disabled trade action control is changed to an enabled trade action control. When the timer expires, the timing module 616 sends a message to the example control management module 614 to process.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
detecting, via a user interface generated by a computing device, an activation event associated with an interface control corresponding to a trade action, wherein the activation event is a gestural input received via the generated user interface;
detecting, in response to the detected activation event, an enabling event associated with the interface control;
determining whether the enabling event satisfies one or more activation criterion; and
in response to the enabling event satisfying the one or more activation criterion, initiating the trade action associated with the activated interface control.

2. A method as described in claim 1, wherein the activation event is a selection of the interface control.

3. A method as described in claim 1, further comprising selecting the activated interface control to execute the trade action.

4. A method as described in claim 1, wherein the interface control is to occupy a portion of the user interface, and further comprising:
detecting a second activation event outside the portion of the user interface; and
de-activating the interface control from execution of the trade action.

5. A method as described in claim 1, wherein activating the interface control further comprises modifying a component of the interface control to enable execution of the trade action.

6. A method as described in claim 1, wherein the activation criterion is a period of time, and wherein satisfying the activation criterion further comprises detecting the enabling event for the period of time.

7. A method as described in claim 1, wherein the enabling event is a series of gestural inputs with respect to the interface control.

8. A method as described in claim 1, wherein the gestural input is a sweep along the user interface.

9. A method as described in claim 8, further comprising updating an interface cell associated with the interface control based on a direction of the sweep.

10. A method as described in claim 9, wherein updating the interface cell further comprises increasing a value of the interface cell.

11. A method as described in claim 9, wherein updating the interface cell further comprises decreasing a value of the interface cell.

12. An apparatus comprising:
an activation event detecting module to detect an activation event via a user interface, the user interface to include an interface control that is to correspond to a trade action, and wherein the user interface is to receive the activation event as a gestural input;
an enabling event detecting module to detect an enabling event associated with the interface control;
a criterion satisfying detection module to compare the enabling event to an activation criterion; and
a trade action execution module to, based on the comparison, execute the trade action that is to correspond to the interface control.

13. An apparatus as described in claim 12, wherein the activation event detecting module is to detect selection of the interface control.

14. An apparatus as described in claim 12, further comprising a user interface rendering module to update the user interface to display an activated interface control.

15. An apparatus as described in claim 14, wherein the user interface rending module is to update a value of an interface cell associated with the interface control in a sequence based on a direction associated with the gestural input.

16. An apparatus as described in claim 12, further comprising a timing module to de-activate the activated interface control after a period of time.

17. An apparatus as described in claim 12, wherein the activation criterion is a threshold area of the interface control.

18. An apparatus as described in claim 17, wherein the enabling event detecting module is to detect a series of gestural inputs over an area of the interface control.

19. An apparatus as described in claim 12, wherein the activation criterion is a period of time.

20. A tangible computer readable storage medium including computer program code to be executed by a processor, the computer program code, when executed, to implement a method comprising:
detecting, via a user interface generated by a computing device, an activation event associated with an interface control corresponding to a trade action, wherein the activation event is a gestural input received via the generated user interface;
detecting, in response to the detected activation event, an enabling event associated with the interface control;
determining whether the enabling event satisfies one or more activation criterion; and
in response to the enabling event satisfying the one or more activation criterion, initiating the trade action associated with the activated interface control.
